(19) United States
(12) Patent Application Publication
(10) Pub. No.: US 2025/0103044 A1
(43) Pub. Date: Mar. 27, 2025

(54) VIRTUAL SENSOR GENERATION AND INSTANTIATION WITHIN A DIGITAL TWIN

(71) Applicant: Tyco Fire & Security GmbH, Neuhausen am Rheinfall (CH)

(72) Inventors: Dominick J. O'Dierno, Mt Pleasant, WI (US); Theresa Thy N. Gillette, Wichita, KS (US); David W. Guelfo, Milwaukee, WI (US); Mason S. DeWald, Wichita, KS (US)

(21) Appl. No.: 18/895,144

(22) Filed: Sep. 24, 2024

Related U.S. Application Data
(60) Provisional application No. 63/540,581, filed on Sep. 26, 2023.

(51) Int. Cl. G05B 23/02

(52) U.S. Cl. CPC G05B 23/0297

(57) ABSTRACT

A method includes generating or obtaining, by one or more processors, a digital twin of a building; generating, by the one or more processors, a virtual sensor configured to detect an event associated with one or more pieces of building equipment of the building, the virtual sensor comprising a machine learning model configured to detect the event using data obtained from and/or relating to the one or more pieces of building equipment; adding, by the one or more processors, a virtual sensor entity and one or more virtual sensor relationships to the digital twin; detecting, by the one or more processors using the virtual sensor, that the event has occurred; and, in response to detecting the event has occurred, updating the virtual sensor entity to include an indication that the event has occurred.

### CROSS-REFERENCE TO RELATED PATENT APPLICATIONS

This application claims the benefit of an priority to U.S. Provisional Patent Application No. 63/540,581, filed Sep. 26, 2023, the entire disclosure of which is incorporated by reference herein.

### BACKGROUND

The present disclosure relates generally to detecting events associated with various systems of a building associated with a digital twin.

In some instances, the detected events may be associated with a heating, ventilation, and/or conditioning (HVAC) system. An HVAC system is used to provide proper ventilation and maintain air quality in a confined space, for example, a commercial or household building. The HVAC system typically includes a refrigerant circuit having a compressor, a condenser, an expansion device, and an evaporator. The refrigerant circuit includes various pipes or conduits connected between the compressor, the condenser, the expansion device, and the evaporator to facilitate refrigerant flow therebetween. The pipes or conduits may be susceptible to leakage. Refrigerant, if leaked, can mix with supply air and enter a space served by the HVAC system. In some instances, refrigerants may also be flammable. In these instances, it is possible for leaked refrigerant to catch fire and cause damage to components of HVAC system. Additionally, in some instances, refrigerants may be toxic. Thus, leaked refrigerant interacting with occupants can potentially cause various health hazards.

In some other instances, the detected events may be any of a variety of system malfunctions or other events generally relating to systems, components, or devices represented within a digital twin.

### SUMMARY

One implementation of the present disclosure is a method. The method includes generating or obtaining, by one or more processors, a digital twin of a building, the digital twin comprising a plurality of entities and a plurality of relationships between the plurality of entities, the plurality of entities comprising digital representations of one or more pieces of building equipment of the building. The method further includes generating, by the one or more processors, a virtual sensor configured to detect an event associated with the one or more pieces of building equipment, the virtual sensor comprising a machine learning model configured to detect the event using data obtained from and/or relating to the one or more pieces of building equipment. The method further includes adding, by the one or more processors, a virtual sensor entity and one or more virtual sensor relationships to the digital twin, the virtual sensor entity corresponding to the virtual sensor, the one or more virtual sensor relationships connecting the virtual sensor entity to one or more of the plurality of entities representing the one or more pieces of building equipment. The method further includes detecting, by the one or more processors using the virtual sensor, that the event has occurred. The method further includes, in response to detecting the event has occurred, updating the virtual sensor entity to include an indication that the event has occurred.

Another implementation of the present disclosure is a building system of a building. The building system includes one or more memory devices having instructions thereon, that, when executed by one or more processors, cause the one or more processors to generate or obtain a digital twin of the building, the digital twin comprising a plurality of entities and a plurality of relationships between the plurality of entities, the plurality of entities comprising digital representations of one or more pieces of building equipment of the building. The instructions, when executed by the one or more processors, further cause the one or more processors to generate a virtual sensor configured to detect an event associated with the one or more pieces of building equipment, the virtual sensor comprising a machine learning model configured to detect the event using data obtained from and/or relating to the one or more pieces of building equipment. The instructions, when executed by the one or more processors, further cause the one or more processors to add a virtual sensor entity and one or more virtual sensor relationships to the digital twin, the virtual sensor entity corresponding to the virtual sensor, the one or more virtual sensor relationships connecting the virtual sensor entity to one or more of the plurality of entities representing the one or more pieces of building equipment. The instructions, when executed by the one or more processors, further cause the one or more processors to detect, using the virtual sensor, that the event has occurred. The instructions, when executed by the one or more processors, further cause the one or more processors to, in response to detecting the event has occurred, updating the virtual sensor entity to include an indication that the event has occurred.

Yet another implementation of the present disclosure is one or more memory devices having instructions thereon that, when executed by one or more processors, cause the one or more processors to generate a virtual sensor configured to detect an event associated with one or more pieces of building equipment of a building, the virtual sensor comprising a machine learning model configured to detect the event using data obtained from and/or relating to the one or more pieces of building equipment. The instructions, when executed by the one or more processors, further cause the one or more processors to add a virtual sensor entity and one or more virtual sensor relationships to a digital twin, the digital twin comprising a plurality of entities and a plurality of relationships between the plurality of entities, the plurality of entities comprising digital representations of the one or more pieces of building equipment, the virtual sensor entity corresponding to the virtual sensor, the one or more virtual sensor relationships connecting the virtual sensor entity to one or more of the plurality of entities representing the one or more pieces of building equipment. The instructions, when executed by the one or more processors, further cause the one or more processors to detect, using the virtual sensor, that the event has occurred. The instructions, when executed by the one or more processors, further cause the one or more processors to, in response to detecting the event has occurred, updating the virtual sensor entity to include an indication that the event has occurred.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a building data platform including an edge platform, a cloud platform, and a twin manager, according to an exemplary embodiment.

FIG. 2 is a graph projection of the twin manager of FIG. 1 including application programming interface (API) data, capability data, policy data, and services, according to an exemplary embodiment.

FIG. 3 is a block diagram of a system for managing a digital twin where an artificial intelligence agent can be executed to infer information for an entity of a graph, according to an exemplary embodiment.

FIG. 4 is a block diagram of metadata sources being integrated with the building data platform of FIG. 1, according to an exemplary embodiment.

FIG. 5 is another block diagram of metadata sources being integrated with the building data platform of FIG. 1 and including AI agents, according to an exemplary embodiment.

FIG. 6 is a block diagram of inferences and predictions of the CAO AI agent and the EPM AI agent being presented in a three-dimensional graphic interface, according to an exemplary embodiment.

FIG. 7 is a flowchart depicting method steps for detecting and predicting events within a building, according to some embodiments.

### DETAILED DESCRIPTION

### Overview

Referring generally to the FIGURES, systems and methods for generating three dimensional graphical models (e.g., building models) with intelligent visualization are shown, according to various exemplary embodiments. For example, the systems and methods described herein may pull in or ingest various information, such as a plurality of digital twins (e.g., graph projections associated with virtually represented assets), a variety of externally accessed information relating to one or more virtually represented assets, and/or various other information relating to, associated with, or otherwise pertaining to a graphical model to be generated and displayed to a user.

In some instances, a digital twin can be a virtual representation of a building and/or an entity of the building (e.g., space, piece of equipment, occupant, etc.). Furthermore, the digital twin can represent a service performed in a building, e.g., facility management, clean air optimization, energy prediction, equipment maintenance, etc. In some instances, the systems and methods described herein allow for the cross-correlation of information received or ingested from one or more external sources or systems (e.g., via one or more external access application programming interface (APIs) or software development kit (SDK) components) by using one or more device or asset identification numbers to determine a location of a corresponding virtual asset (e.g., associated with an ingested digital twin) within the graphical model. The cross-correlated information may then be visually represented within the graphical model by displaying the cross-correlated information near the corresponding virtual asset or by utilizing the cross-correlated information to alter a visual representation of the virtual asset itself (e.g., creating a heat map at a cross-correlated location or space within the graphical model, highlighting the corresponding virtual asset within the graphical model, etc.).

In some embodiments, each digital twin can include an information data store and a connector. The information data store can store the information describing the entity that the digital twin operates for (e.g., attributes of the entity, measurements associated with the entity, control points or commands of the entity, etc.). In some embodiments, the data store can be a graph including various nodes and edges. The connector can be a software component that provides telemetry from the entity (e.g., physical device) to the information store. In some embodiments, the systems and methods described herein are configured to allow for various cross-correlated information received from or ingested from the one or more external sources or systems to be pushed to the corresponding digital twin associated with the virtual asset and used to update one or more pieces of stored information of the digital twin.

In some embodiments, the systems and methods described herein can cause the graphical model to render in a user interface of a user device and allow a user to view the model, view information associated with the components of the model, and/or navigate throughout the model. In some embodiments, a user can provide commands and/or inputs via the user device within the rendered graphical model to request information from and/or push data to one or more of the digital twins and/or one or more external sources or systems associated with one or more virtual assets. In some instances, the commands and/or inputs may further trigger one or more actions by one or more physical assets (e.g., increasing the set point temperature of an air conditioning unit) corresponding to one or more virtual assets interacted with by the user within the graphical model.

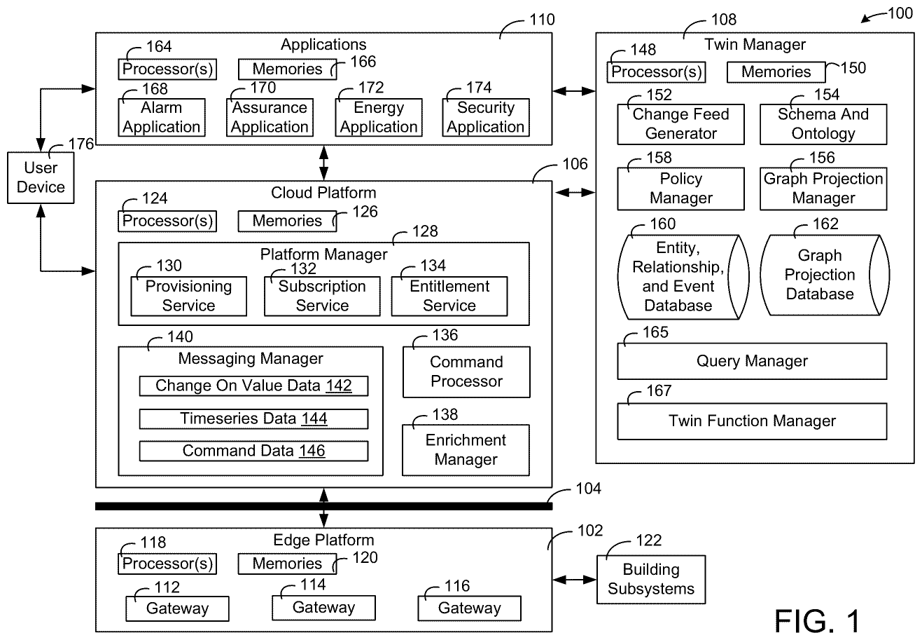

Referring now to FIG. 1, a building data platform 100 including an edge platform 102, a cloud platform 106, and a twin manager 108 are shown, according to an exemplary embodiment. The edge platform 102, the cloud platform 106, and the twin manager 108 can each be separate services deployed on the same or different computing systems. In some embodiments, the cloud platform 106 and the twin manager 108 are implemented in off premises computing systems, e.g., outside a building. The edge platform 102 can be implemented on-premises, e.g., within the building. However, any combination of on-premises and off-premises components of the building data platform 100 can be implemented.

The building data platform 100 includes applications 110. The applications 110 can be various applications that operate to manage the building subsystems 122. The applications 110 can be remote or on-premises applications (or a hybrid of both) that run on various computing systems. The applications 110 can include an alarm application 168 configured to manage alarms for the building subsystems 122. The applications 110 include an assurance application 170 that implements assurance services for the building subsystems 122. In some embodiments, the applications 110 include an energy application 172 configured to manage the energy usage of the building subsystems 122. The applications 110 include a security application 174 configured to manage security systems of the building.

In some embodiments, the applications 110 and/or the cloud platform 106 interacts with a user device 176. In some embodiments, a component or an entire application of the applications 110 runs on the user device 176. The user device 176 may be a laptop computer, a desktop computer, a smartphone, a tablet, and/or any other device with an input interface (e.g., touch screen, mouse, keyboard, etc.) and an output interface (e.g., a speaker, a display, etc.).

The applications 110, the twin manager 108, the cloud platform 106, and the edge platform 102 can be implemented on one or more computing systems, e.g., on processors and/or memory devices. For example, the edge platform 102 includes processor(s) 118 and memories 120, the cloud platform 106 includes processor(s) 124 and memories 126, the applications 110 include processor(s) 164 and memories 166, and the twin manager 108 includes processor(s) 148 and memories 150.

The processors can be general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.).

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

The edge platform 102 can be configured to provide connection to the building subsystems 122. The edge platform 102 can receive messages from the building subsystems 122 and/or deliver messages to the building subsystems 122. The edge platform 102 includes one or multiple gateways, e.g., the gateways 112-116. The gateways 112-116 can act as a gateway between the cloud platform 106 and the building subsystems 122. The gateways 112-116 can be or function similar to the gateways described in U.S. patent application Ser. No. 17/127,303, filed Dec. 18, 2020, the entirety of which is incorporated by reference herein. In some embodiments, the applications 110 can be deployed on the edge platform 102. In this regard, lower latency in management of the building subsystems 122 can be realized.

The edge platform 102 can be connected to the cloud platform 106 via a network 104. The network 104 can communicatively couple the devices and systems of building data platform 100. In some embodiments, the network 104 is at least one of and/or a combination of a Wi-Fi network, a wired Ethernet network, a ZigBee network, a Bluetooth network, and/or any other wireless network. The network 104 may be a local area network or a wide area network (e.g., the Internet, a building WAN, etc.) and may use a variety of communications protocols (e.g., BACnet, IP, LON, etc.). The network 104 may include routers, modems, servers, cell towers, satellites, and/or network switches. The network 104 may be a combination of wired and wireless networks.

The cloud platform 106 can be configured to facilitate communication and routing of messages between the applications 110, the twin manager 108, the edge platform 102, and/or any other system. The cloud platform 106 can include a platform manager 128, a messaging manager 140, a command processor 136, and an enrichment manager 138. In some embodiments, the cloud platform 106 can facilitate messaging between the building data platform 100 via the network 104.

The messaging manager 140 can be configured to operate as a transport service that controls communication with the building subsystems 122 and/or any other system, e.g., managing commands to devices (C2D), commands to connectors (C2C) for external systems, commands from the device to the cloud (D2C), and/or notifications. The messaging manager 140 can receive different types of data from the applications 110, the twin manager 108, and/or the edge platform 102. The messaging manager 140 can receive change on value data 142, e.g., data that indicates that a value of a point has changed. The messaging manager 140 can receive time series data 144, e.g., a time correlated series of data entries each associated with a particular time stamp. Furthermore, the messaging manager 140 can receive command data 146. All of the messages handled by the cloud platform 106 can be handled as an event, e.g., the data 142-146 can each be packaged as an event with a data value occurring at a particular time (e.g., a temperature measurement made at a particular time).

The cloud platform 106 includes a command processor 136. The command processor 136 can be configured to receive commands to perform an action from the applications 110, the building subsystems 122, the user device 176, etc. The command processor 136 can manage the commands, determine whether the commanding system is authorized to perform the particular commands, and communicate the commands to the commanded system, e.g., the building subsystems 122 and/or the applications 110. The commands could be a command to change an operational setting that control environmental conditions of a building, a command to run analytics, etc.

The cloud platform 106 includes an enrichment manager 138. The enrichment manager 138 can be configured to enrich the events received by the messaging manager 140. The enrichment manager 138 can be configured to add contextual information to the events. The enrichment manager 138 can communicate with the twin manager 108 to retrieve the contextual information. In some embodiments, the contextual information is an indication of information related to the event. For example, if the event is a time series temperature measurement of a thermostat, contextual information such as the location of the thermostat (e.g., what room), the equipment controlled by the thermostat (e.g., what VAV), etc. can be added to the event. In this regard, when a consuming application, e.g., one of the applications 110 receives the event, the consuming application can operate based on the data of the event, the temperature measurement, and also the contextual information of the event.

The enrichment manager 138 can solve a problem that when a device produces a significant amount of information, the information may contain simple data without context. An example might include the data generated when a user scans a badge at a badge scanner of the building subsystems 122. This physical event can generate an output event including such information as “DeviceBadgeScannerID,” “BadgeID,” and/or “Date/Time.” However, if a system sends this data to a consuming application, e.g., Consumer A and a Consumer B, each customer may need to call the building data platform knowledge service to query information with queries such as, “What space, build, floor is that badge scanner in?” or “What user is associated with that badge?”

By performing enrichment on the data feed, a system can be able to perform inferences on the data. A result of the enrichment may be transformation of the message “DeviceBadgeScannerId, BadgeId, Date/Time,” to “Region, Building, Floor, Asset, DeviceId, BadgeId, UserName, EmployeeId, Date/Time Scanned.” This can be a significant optimization, as a system can reduce the number of calls by 1/n, where n is the number of consumers of this data feed.

By using this enrichment, a system can also have the ability to filter out undesired events. If there are 100 building in a campus that receive 100,000 events per building each hour, but only 1 building is actually commissioned, only 1/10 of the events are enriched. By looking at what events are enriched and what events are not enriched, a system can do traffic shaping of forwarding of these events to reduce the cost of forwarding events that no consuming application wants or reads.

An example of an event received by the enrichment manager 138 may be:

{
“id”: “someguid”,
“eventType”: “Device_Heartbeat”,
“eventTime”: “2018-01-27T00:00:00+00:00”
“eventValue”: 1,
“deviceID”: “someguid”
}

An example of an enriched event generated by the enrichment manager 138 may be:

{
“id”: “someguid”,
“eventType”: “Device_Heartbeat”,
“eventTime”: “2018-01-27T00:00:00+00:00”
“eventValue”: 1,
“deviceID”: “someguid”,
“buildingName”: “Building-48”,
“buildingID”: “SomeGuid”,
“panelID”: “SomeGuid”,
“panelName”: “Building-48-Panel-13”,
“cityID”: 371,
“cityName”: “Milwaukee”,
“stateID”: 48,
“stateName”: “Wisconsin (WI)”,
“countryID”: 1,
“countryName”: “United States”
}

By receiving enriched events, an application of the applications 110 can be able to populate and/or filter what events are associated with what areas. Furthermore, user interface generating applications can generate user interfaces that include the contextual information based on the enriched events.

The cloud platform 106 includes a platform manager 128. The platform manager 128 can be configured to manage the users and/or subscriptions of the cloud platform 106. For example, what subscribing building, user, and/or tenant utilizes the cloud platform 106. The platform manager 128 includes a provisioning service 130 configured to provision the cloud platform 106, the edge platform 102, and the twin manager 108. The platform manager 128 includes a subscription service 132 configured to manage a subscription of the building, user, and/or tenant while the entitlement service 134 can track entitlements of the buildings, users, and/or tenants.

The twin manager 108 can be configured to manage and maintain a digital twin. The digital twin can be a digital representation of the physical environment, e.g., a building. The twin manager 108 can include a change feed generator 152, a schema and ontology 154, a graph projection manager 156, a policy manager 158, an entity, relationship, and event database 160, and a graph projection database 162.

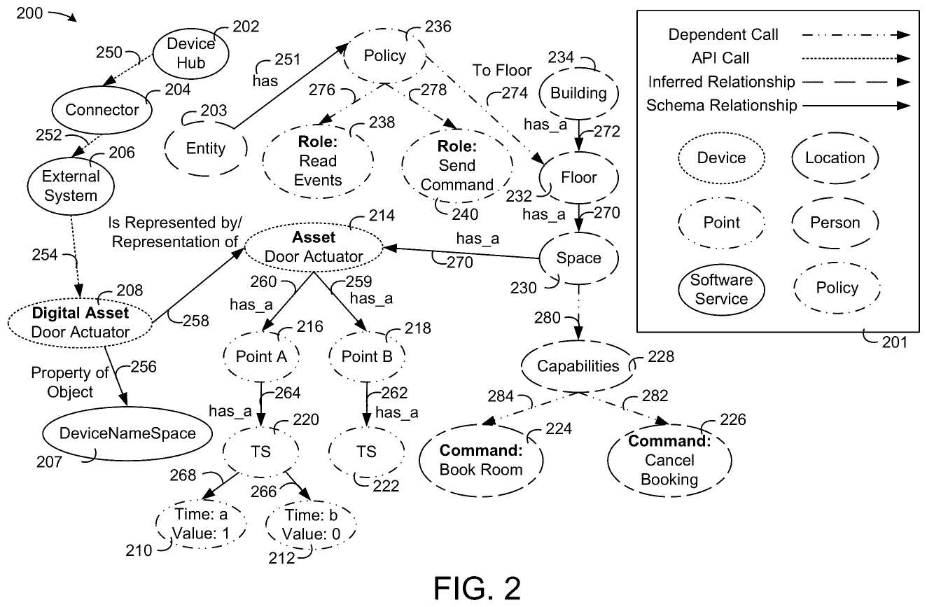

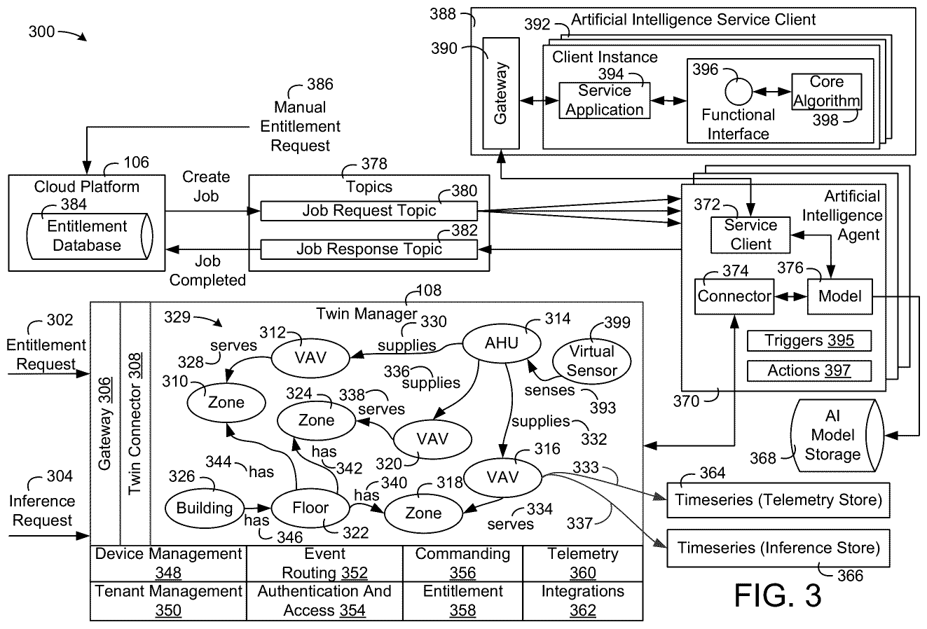

The graph projection manager 156 can be configured to construct graph projections and store the graph projections in the graph projection database 162. Example of graph projections are shown in FIGS. 2 and 3. Entities, relationships, and events can be stored in the database 160. The graph projection manager 156 can retrieve entities, relationships, and/or events from the database 160 and construct a graph projection based on the retrieved entities, relationships and/or events. In some embodiments, the database 160 includes an entity-relationship collection for multiple subscriptions.

In some embodiment, the graph projection manager 156 generates a graph projection for a particular user, application, subscription, and/or system. In this regard, the graph projection can be generated based on policies for the particular user, application, and/or system in addition to an ontology specific for that user, application, and/or system. In this regard, an entity could request a graph projection and the graph projection manager 156 can be configured to generate the graph projection for the entity based on policies and an ontology specific to the entity. The policies can indicate what entities, relationships, and/or events the entity has access to. The ontology can indicate what types of relationships between entities the requesting entity expects to see, e.g., floors within a building, devices within a floor, etc. Another requesting entity may have an ontology to see devices within a building and applications for the devices within the graph.

The graph projections generated by the graph projection manager 156 and stored in the graph projection database 162 can be a knowledge graph and is an integration point. For example, the graph projections can represent floor plans and systems associated with each floor. Furthermore, the graph projections can include events, e.g., telemetry data of the building subsystems 122. The graph projections can show application services as nodes and API calls between the services as edges in the graph. The graph projections can illustrate the capabilities of spaces, users, and/or devices. The graph projections can include indications of the building subsystems 122, e.g., thermostats, cameras, VAVs, etc. The graph projection database 162 can store graph projections that keep up a current state of a building.

The graph projections of the graph projection database 162 can be digital twins of a building. Digital twins can be digital replicas of physical entities (e.g., locations, spaces, equipment, assets, etc.) that enable an in-depth analysis of data of the physical entities and provide the potential to monitor systems to mitigate risks, manage issues, and utilize simulations to test future solutions. Digital twins can play an important role in helping technicians find the root cause of issues and solve problems faster, in supporting safety and security protocols, and in supporting building managers in more efficient use of energy and other facilities resources. Digital twins can be used to enable and unify security systems, employee experience, facilities management, sustainability, etc.

In some embodiments the enrichment manager 138 can use a graph projection of the graph projection database 162 to enrich events. In some embodiments, the enrichment manager 138 can identify nodes and relationships that are associated with, and are pertinent to, the device that generated the event. For example, the enrichment manager 138 could identify a thermostat generating a temperature measurement event within the graph. The enrichment manager 138 can identify relationships between the thermostat and spaces, e.g., a zone that the thermostat is located in. The enrichment manager 138 can add an indication of the zone to the event.

Furthermore, the command processor 136 can be configured to utilize the graph projections to command the building subsystems 122. The command processor 136 can identify a policy for a commanding entity within the graph projection to determine whether the commanding entity has the ability to make the command. For example, the command processor 136, before allowing a user to make a command, may determine, based on the graph projection database 162, that the user has a policy to be able to make the command.

In some embodiments, the policies can be conditional based policies. For example, the building data platform 100 can apply one or more conditional rules to determine whether a particular system has the ability to perform an action. In some embodiments, the rules analyze a behavioral based biometric. For example, a behavioral based biometric can indicate normal behavior and/or normal behavior rules for a system. In some embodiments, when the building data platform 100 determines, based on the one or more conditional rules, that an action requested by a system does not match a normal behavior, the building data platform 100 can deny the system the ability to perform the action and/or request approval from a higher level system.

For example, a behavior rule could indicate that a user has access to log into a system with a particular IP address between 8 A.M. through 5 P.M. However, if the user logs in to the system at 7 P.M., the building data platform 100 may contact an administrator to determine whether to give the user permission to log in.

The change feed generator 152 can be configured to generate a feed of events that indicate changes to the digital twin, e.g., to the graph. The change feed generator 152 can track changes to the entities, relationships, and/or events of the graph. For example, the change feed generator 152 can detect an addition, deletion, and/or modification of a node or edge of the graph, e.g., changing the entities, relationships, and/or events within the database 160. In response to detecting a change to the graph, the change feed generator 152 can generate an event summarizing the change. The event can indicate what nodes and/or edges have changed and how the nodes and edges have changed. The events can be posted to a topic by the change feed generator 152.

The change feed generator 152 can implement a change feed of a knowledge graph. The building data platform 100 can implement a subscription to changes in the knowledge graph. When the change feed generator 152 posts events in the change feed, subscribing systems or applications can receive the change feed event. By generating a record of all changes that have happened, a system can stage data in different ways, and then replay the data back in whatever order the system wishes. This can include running the changes sequentially one by one and/or by jumping from one major change to the next. For example, to generate a graph at a particular time, all change feed events up to the particular time can be used to construct the graph.

The change feed can track the changes in each node in the graph and the relationships related to them, in some embodiments. If a user wants to subscribe to these changes and the user has proper access, the user can simply submit a web API call to have sequential notifications of each change that happens in the graph. A user and/or system can replay the changes one by one to reinstitute the graph at any given time slice. Even though the messages are “thin” and only include notification of change and the reference “id/seq id,” the change feed can keep a copy of every state of each node and/or relationship so that a user and/or system can retrieve those past states at any time for each node. Furthermore, a consumer of the change feed could also create dynamic “views” allowing different “snapshots” in time of what the graph looks like from a particular context. While the twin manager 108 may contain the history and the current state of the graph based upon schema evaluation, a consumer can retain a copy of that data, and thereby create dynamic views using the change feed.

The schema and ontology 154 can define the message schema and graph ontology of the twin manager 108. The message schema can define what format messages received by the messaging manager 140 should have, e.g., what parameters, what formats, etc. The ontology can define graph projections, e.g., the ontology that a user wishes to view. For example, various systems, applications, and/or users can be associated with a graph ontology. Accordingly, when the graph projection manager 156 generates a graph projection for a user, system, or subscription, the graph projection manager 156 can generate a graph projection according to the ontology specific to the user. For example, the ontology can define what types of entities are related in what order in a graph, for example, for the ontology for a subscription of “Customer A,” the graph projection manager 156 can create relationships for a graph projection based on the rule:
Region [symbol] Building [symbol] Floor [symbol] Space [symbol] Asset

For the ontology of a subscription of “Customer B,” the graph projection manager 156 can create relationships based on the rule:
Building [symbol] Floor [symbol] Asset

The policy manager 158 can be configured to respond to requests from other applications and/or systems for policies. The policy manager 158 can consult a graph projection to determine what permissions different applications, users, and/or devices have. The graph projection can indicate various permissions that different types of entities have and the policy manager 158 can search the graph projection to identify the permissions of a particular entity. The policy manager 158 can facilitate fine grain access control with user permissions. The policy manager 158 can apply permissions across a graph, e.g., if “user can view all data associated with floor 1” then they see all subsystem data for that floor, e.g., surveillance cameras, HVAC devices, fire detection and response devices, etc.

The twin manager 108 includes a query manager 165 and a twin function manager 167. The query manger 164 can be configured to handle queries received from a requesting system, e.g., the user device 176, the applications 110, and/or any other system. The query manager 165 can receive queries that include query parameters and context. The query manager 165 can query the graph projection database 162 with the query parameters to retrieve a result. The query manager 165 can then cause an event processor, e.g., a twin function, to operate based on the result and the context. In some embodiments, the query manager 165 can select the twin function based on the context and/or perform operates based on the context. In some embodiments, the query manager 165 is configured to perform a variety of differing operations. For example, in some instances, the query manager 165 is configured to perform any of the operations performed by the query manager described in U.S. patent application Ser. No. 17/537,046, filed Nov. 29, 2021, the entirety of which is incorporated by reference herein.

The twin function manager 167 can be configured to manage the execution of twin functions. The twin function manager 167 can receive an indication of a context query that identifies a particular data element and/or pattern in the graph projection database 162. Responsive to the particular data element and/or pattern occurring in the graph projection database 162 (e.g., based on a new data event added to the graph projection database 162 and/or change to nodes or edges of the graph projection database 162), the twin function manager 167 can cause a particular twin function to execute. The twin function can be executed based on an event, context, and/or rules. The event can be data that the twin function executes against. The context can be information that provides a contextual description of the data, e.g., what device the event is associated with, what control point should be updated based on the event, etc. The twin function manager 167 can be configured to perform a variety of differing operations. For example, in some instances, the twin function manager 167 is configured to perform any of the operations of the twin function manager described in U.S. patent application Ser. No. 17/537,046, referenced above.

Referring now to FIG. 2, a graph projection 200 of the twin manager 108 including application programming interface (API) data, capability data, policy data, and services is shown, according to an exemplary embodiment. The graph projection 200 includes nodes 202-240 and edges 250-284. The nodes 202-240 and the edges 250-284 are defined according to the key 201. The nodes 202-240 represent different types of entities, devices, locations, points, persons, policies, and software services (e.g., API services). The edges 250-284 represent relationships between the nodes 202-240, e.g., dependent calls, API calls, inferred relationships, and schema relationships (e.g., BRICK relationships).

The graph projection 200 includes a device hub 202 which may represent a software service that facilitates the communication of data and commands between the cloud platform 106 and a device of the building subsystems 122, e.g., door actuator 214. The device hub 202 is related to a connector 204, an external system 206, and a digital asset “Door Actuator” 208 by edge 250, edge 252, and edge 254.

The cloud platform 106 can be configured to identify the device hub 202, the connector 204, the external system 206 related to the door actuator 214 by searching the graph projection 200 and identifying the edges 250-254 and edge 258. The graph projection 200 includes a digital representation of the “Door Actuator,” node 208. The digital asset “Door Actuator” 208 includes a “DeviceNameSpace” represented by node 207 and related to the digital asset “Door Actuator” 208 by the “Property of Object” edge 256.

The “Door Actuator” 214 has points and time series. The “Door Actuator” 214 is related to “Point A” 216 by a “has_a” edge 260. The “Door Actuator” 214 is related to “Point B” 218 by a “has_A” edge 259. Furthermore, time series associated with the points A and B are represented by nodes “TS” 220 and “TS” 222. The time series are related to the points A and B by “has_a” edge 264 and “has_a” edge 262. The time series “TS” 220 has particular samples, sample 210 and 212 each related to “TS” 220 with edges 268 and 266 respectively. Each sample includes a time and a value. Each sample may be an event received from the door actuator that the cloud platform 106 ingests into the entity, relationship, and event database 160, e.g., ingests into the graph projection 200.

The graph projection 200 includes a building 234 representing a physical building. The building includes a floor represented by floor 232 related to the building 234 by the “has_a” edge from the building 234 to the floor 232. The floor has a space indicated by the edge “has_a” 270 between the floor 232 and the space 230. The space has particular capabilities, e.g., is a room that can be booked for a meeting, conference, private study time, etc. Furthermore, the booking can be canceled. The capabilities for the floor 232 are represented by capabilities 228 related to space 230 by edge 280. The capabilities 228 are related to two different commands, command “book room” 224 and command “cancel booking” 226 related to capabilities 228 by edge 284 and edge 282 respectively.

If the cloud platform 106 receives a command to book the space represented by the node, space 230, the cloud platform 106 can search the graph projection 200 for the capabilities for the 228 related to the space 230 to determine whether the cloud platform 106 can book the room.

In some embodiments, the cloud platform 106 could receive a request to book a room in a particular building, e.g., the building 234. The cloud platform 106 could search the graph projection 200 to identify spaces that have the capabilities to be booked, e.g., identify the space 230 based on the capabilities 228 related to the space 230. The cloud platform 106 can reply to the request with an indication of the space and allow the requesting entity to book the space 230.

The graph projection 200 includes a policy 236 for the floor 232. The policy 236 is related set for the floor 232 based on a “To Floor” edge 274 between the policy 236 and the floor 232. The policy 236 is related to different roles for the floor 232, read events 238 via edge 276 and send command 240 via edge 278. The policy 236 is set for the entity 203 based on has edge 251 between the entity 203 and the policy 236.

The twin manager 108 can identify policies for particular entities, e.g., users, software applications, systems, devices, etc. based on the policy 236. For example, if the cloud platform 106 receives a command to book the space 230. The cloud platform 106 can communicate with the twin manager 108 to verify that the entity requesting to book the space 230 has a policy to book the space. The twin manager 108 can identify the entity requesting to book the space as the entity 203 by searching the graph projection 200. Furthermore, the twin manager 108 can further identify the edge has 251 between the entity 203 and the policy 236 and the edge 278 between the policy 236 and the command 240.

Furthermore, the twin manager 108 can identify that the entity 203 has the ability to command the space 230 based on the edge 274 between the policy 236 and the floor 232 and the edge 270 between the floor 232 and the space 230. In response to identifying the entity 203 has the ability to book the space 230, the twin manager 108 can provide an indication to the cloud platform 106.

Furthermore, if the entity 203 makes a request to read events for the space 230, e.g., the sample 210 and the sample 212, the twin manager 108 can identify the edge has 251 between the entity 203 and the policy 236, the edge 276 between the policy 236 and the read events 238, the edge 274 between the policy 236 and the floor 232, the “has_a” edge 270 between the floor 232 and the space 230, the edge 271 between the space 230 and the door actuator 214, the edge 260 between the door actuator 214 and the point A 216, the “has_a” edge 264 between the point A 216 and the TS 220, and the edges 268 and 266 between the TS 220 and the samples 210 and 212 respectively.

Additional examples of potential graph projections can be found in U.S. patent application Ser. No. 17/537,046, referenced above. However, it will be appreciated that a variety of differing graph projections may be implemented, as desired for a given application or scenario. As such, the example graph projections provided herein are provided as examples, and are in no way meant to be limiting.

Referring now to FIG. 3, a system 300 for managing a digital twin where an artificial intelligence agent can be executed to infer and/or predict information for an entity of a graph is shown, according to an exemplary embodiment. The system 300 can be components of the building data platform 100, e.g., components run on the processors and memories of the edge platform 102, the cloud platform 106, the twin manager 108, and/or the applications 110. The system 300 can, in some implementations, implement a digital twin with artificial intelligence.

A digital twin (or a shadow) may be a computing entity that describes a physical thing (e.g., a building, spaces of a building, devices of a building, people of the building, equipment of the building, etc.) through modeling the physical thing through a set of attributes that define the physical thing. A digital twin can refer to a digital replica of physical assets (a physical device twin) and can be extended to store processes, people, places, systems that can be used for various purposes. The digital twin can include both the ingestion of information and actions learned and executed through artificial intelligence agents.

In FIG. 3, the digital twin can be a graph 329 managed by the twin manager 108 and/or artificial intelligence agents 370. In some embodiments, the digital twin is the combination of the graph 329 with the artificial intelligence agents 370. In some embodiments, the digital twin enables the creation of a chronological time-series database of telemetry events for analytical purposes. In some embodiments, the graph 329 uses the BRICK schema.

The twin manager 108 stores the graph 329 which may be a graph data structure including various nodes and edges interrelating the nodes. The graph 329 may be the same as, or similar to, the graph projections described herein with reference to FIGS. 1 and 2. The graph 329 includes nodes 310-326 and edges 328-346. The graph 329 includes a building node 326 representing a building that has a floor indicated by the “has” edge 346 to the floor node 322. The floor node 322 is relate to a zone node 310 via a “has” edge 344 indicating that the floor represented by the node 322 has a zone represented by the zone 310.

The floor node 322 is related to the zone node 318 by the “has” edge 340 indicating that the floor represented by the floor node 322 has another zone represented by the zone node 318. The floor node 322 is related to another zone node 324 via a “has” edge 342 representing that the floor represented by the floor node 322 has a third zone represented by the zone node 324.

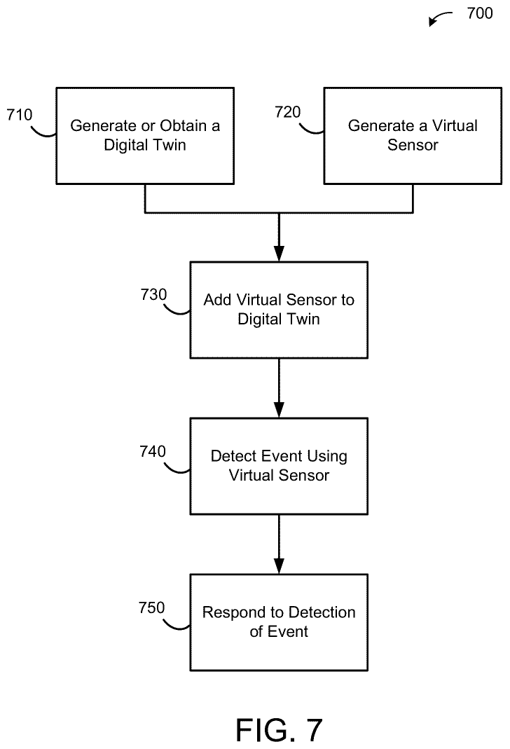

The graph 329 includes an AHU node 314 representing an AHU of the building represented by the building node 326. The AHU node 314 is related by a “senses” edge 393 to a virtual sensor node 399 to represent that a virtual sensor (described in detail below, with reference to FIG. 7) represented by the virtual sensor node 399 senses an event (e.g., a refrigerant leakage associated with a refrigerant circuit of the AHU) associated with the AHU represented by the AHU node 314. The AHU node 314 is related by a “supplies” edge 330 to the VAV node 312 to represent that the AHU represented by the AHU node 314 supplies air to the VAV represented by the VAV node 312. The AHU node 314 is related by a “supplies” edge 336 to the VAV node 320 to represent that the AHU represented by the AHU node 314 supplies air to the VAV represented by the VAV node 320. The AHU node 314 is related by a “supplies” edge 332 to the VAV node 316 to represent that the AHU represented by the AHU node 314 supplies air to the VAV represented by the VAV node 316.

The VAV node 316 is related to the zone node 318 via the “serves” edge 334 to represent that the VAV represented by the VAV node 316 serves (e.g., heats or cools) the zone represented by the zone node 318. The VAV node 320 is related to the zone node 324 via the “serves” edge 338 to represent that the VAV represented by the VAV node 320 serves (e.g., heats or cools) the zone represented by the zone node 324. The VAV node 312 is related to the zone node 310 via the “serves” edge 328 to represent that the VAV represented by the VAV node 312 serves (e.g., heats or cools) the zone represented by the zone node 310.

Furthermore, the graph 329 includes an edge 333 related to a time series node 364. The time series node 364 can be information stored within the graph 329 and/or can be information stored outside the graph 329 in a different database (e.g., a time series database). In some embodiments, the time series node 364 stores time series data (or any other type of data) for a data point of the VAV represented by the VAV node 316. The data of the time series node 364 can be aggregated and/or collected telemetry data of the time series node 364.

Furthermore, the graph 329 includes an edge 337 related to a time series node 366. The time series node 366 can be information stored within the graph 329 and/or can be information stored outside the graph 329 in a different database (e.g., a time series database). In some embodiments, the time series node 366 stores time series data (or any other type of data) for a data point of the VAV represented by the VAV node 316. The data of the time series node 364 can be inferred information, e.g., data inferred by one of the artificial intelligence agents 370 and written into the time series node 364 by the artificial intelligence agent 370. In some embodiments, the time series 364 and/or 366 are stored in the graph 329 but are stored as references to time series data stored in a time series database.

The twin manager 108 includes various software components. For example, the twin manager 108 includes a device management component 348 for managing devices of a building. The twin manager 108 includes a tenant management component 350 for managing various tenant subscriptions. The twin manager 108 includes an event routing component 352 for routing various events. The twin manager 108 includes an authentication and access component 354 for performing user and/or system authentication and grating the user and/or system access to various spaces, pieces of software, devices, etc. The twin manager 108 includes a commanding component 356 allowing a software application and/or user to send commands to physical devices. The twin manager 108 includes an entitlement component 358 that analyzes the entitlements of a user and/or system and grants the user and/or system abilities based on the entitlements. The twin manager 108 includes a telemetry component 360 that can receive telemetry data from physical systems and/or devices and ingest the telemetry data into the graph 329. Furthermore, the twin manager 108 includes an integrations component 362 allowing the twin manager 108 to integrate with other applications.

The twin manager 108 includes a gateway 306 and a twin connector 308. The gateway 306 can be configured to integrate with other systems and the twin connector 308 can be configured to allow the gateway 306 to integrate with the twin manager 108. The gateway 306 and/or the twin connector 308 can receive an entitlement request 302 and/or an inference request 304. The entitlement request 302 can be a request received from a system and/or a user requesting that an AI agent action be taken by the AI agent 370. The entitlement request 302 can be checked against entitlements for the system and/or user to verify that the action requested by the system and/or user is allowed for the user and/or system. The inference request 304 can be a request that the AI agent 370 generates an inference, e.g., a projection of information, a prediction of a future data measurement, an extrapolated data value, etc.

The cloud platform 106 is shown to receive a manual entitlement request 386. The request 386 can be received from a system, application, and/or user device (e.g., from the applications 110, the building subsystems 122, and/or the user device 176). The manual entitlement request 386 may be a request for the AI agent 370 to perform an action, e.g., an action that the requesting system and/or user has an entitlement for. The cloud platform 106 can receive the manual entitlement request 386 and check the manual entitlement request 386 against an entitlement database 384 storing a set of entitlements to verify that the requesting system has access to the user and/or system. The cloud platform 106, responsive to the manual entitlement request 386 being approved, can create a job for the AI agent 370 to perform. The created job can be added to a job request topic 380 of a set of topics 378.

The job request topic 380 can be fed to AI agents 370. For example, the topics 380 can be fanned out to various AI agents 370 based on the AI agent that each of the topics 380 pertains to (e.g., based on an identifier that identifies an agent and is included in each job of the topic 380). The AI agents 370 include a service client 372, a connector 374, and a model 376. The model 376 can be loaded into the AI agent 370 from a set of AI models stored in the AI model storage 368. The AI model storage 368 can store models for making energy load predictions for a building, weather forecasting models for predicting a weather forecast, action/decision models to take certain actions responsive to certain conditions being met, an occupancy model for predicting occupancy of a space and/or a building, etc. The models of the AI model storage 368 can be neural networks (e.g., convolutional neural networks, recurrent neural networks, deep learning networks, etc.), decision trees, support vector machines, and/or any other type of artificial intelligence, machine learning, and/or deep learning category. In some embodiments, the models are rule based triggers and actions that include various parameters for setting a condition and defining an action.

The AI agent 370 can include triggers 395 and actions 397. The triggers 395 can be conditional rules that, when met, cause one or more of the actions 397. The triggers 395 can be executed based on information stored in the graph 329 and/or data received from the building subsystems 122. The actions 397 can be executed to determine commands, actions, and/or outputs. The output of the actions 397 can be stored in the graph 329 and/or communicated to the building subsystems 122.

The AI agent 370 can include a service client 372 that causes an instance of an AI agent to run. The instance can be hosted by the artificial intelligence service client 388. The client 388 can cause a client instance 392 to run and communicate with the AI agent 370 via a gateway 390. The client instance 392 can include a service application 394 that interfaces with a core algorithm 398 via a functional interface 396. The core algorithm 398 can run the model 376, e.g., train the model 376 and/or use the model 376 to make inferences and/or predictions.

In some embodiments, the core algorithm 398 can be configured to perform learning based on the graph 329. In some embodiments, the core algorithm 398 can read and/or analyze the nodes and relationships of the graph 329 to make decisions. In some embodiments, the core algorithm 398 can be configured to use telemetry data (e.g., the time series data 364) from the graph 329 to make inferences on and/or perform model learning. In some embodiments, the result of the inferences can be the time series 366. In some embodiments, the time series 364 is an input into the model 376 that predicts the time series 366.

In some embodiments, the core algorithm 398 can generate the time series 366 as an inference for a data point, e.g., a prediction of values for the data point at future times. The time series 364 may be actual data for the data point. In this regard, the core algorithm 398 can learn and train by comparing the inferred data values against the true data values. In this regard, the model 376 can be trained by the core algorithm 398 to improve the inferences made by the model 376.

In some embodiments, the system 300 is configured to execute one or more artificial intelligence agents to infer and/or predict information based on information obtained or otherwise retrieved from the graph 329. For example, in some instances, the system 300 may include a variety of different AI agents associated with and configured to analyze information pertaining to any of the various nodes within the graph 329. In some instances, the AI agents may analyze not only the nodes they pertain to, but also a variety of connectors and various triggers associated with those AI agents. For example, in some instances AI agents may be utilized to infer and/or predict information pertaining to the corresponding nodes, and to subsequently trigger various actions within the system 300. In some embodiment, the AI agents may trigger various actions according to associated trigger rules and action rules. The trigger rules and action rules can be logical statements and/or conditions that include parameter values and/or create associated output actions. In some instances, these trigger rules and actions rule may be defined by a user of the system 300. In some other instances, the AI agents may learn, create, or otherwise generate the trigger rules and actions rules based on various desired outcomes (e.g., reduce or minimize energy usage, improve or maximize air circulation, etc.). Example AI agents, triggers, actions, and trigger/rule learning processes are described in U.S. patent application Ser. No. 17/537,046, referenced above.

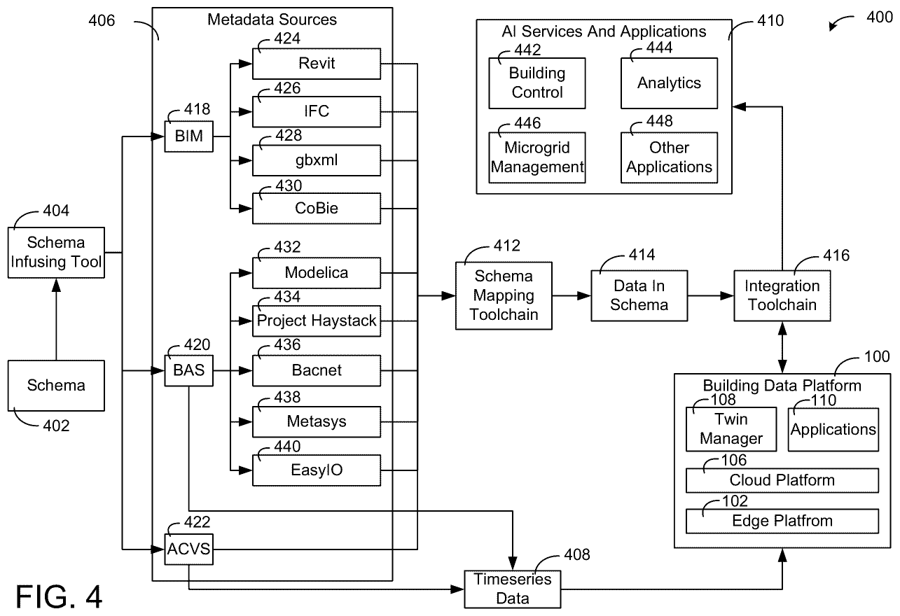

Referring now to FIG. 4, a system 400 where metadata sources 406 are integrated with the building data platform 100 is shown, according to an exemplary embodiment. The system 400 can be implemented on one or more processing circuits, e.g., as instructions stored on one or more memory devices and executed on one or more processors. The memory devices and processors may be the same as or similar to the memory devices and processors described with reference to FIG. 1.

The system 400 includes a schema infusing tool 404. The schema infusing tool can infuse a particular schema, the schema 402, into various systems, services, and/or equipment in order to integrate the data of the various systems, services, and/or equipment into the building data platform 100. The schema 402 may be the BRICK schema, in some embodiments. In some embodiment, the schema 402 may be a schema that uses portions and/or all of the BRICK schema but also includes unique class, relationship types, and/or unique schema rules. The schema infusing tool 404 can infuse the schema 402 into systems such as systems that manage and/or produce building information model (BIM) data 418, building automation system (BAS) systems that produce BAS data 420, and/or access control and video surveillance (ACVS) systems that produce ACVS data 422. In some embodiments, the BIM data 418 can be generated by BIM automation utilities 501.

The BIM data 418 can include data such as Revit data 424 (e.g., Navisworks data), industrial foundation class (IFC) data 426, gbxml data 428, and/or CoBie data 430. The BAS data 420 can include Modelica data 432 (e.g., Control Description Language (CDL) data), Project Haystack data 434, BACnet data 436, Metasys data 438, and/or EasyIO data 440. All of this data can utilize the schema 402 and/or be capable of being mapped into the schema 402.

The BAS data 420 and/or the ACVS data 422 may include time series data 408. The time series data 408 can include trends of data points over time, e.g., a time correlated set of data values each corresponding to time stamps. The time series data can be a time series of data measurements, e.g., temperature measurements, pressure measurements, etc. Furthermore, the time series data can be a time series of inferred and/or predicted information, e.g., an inferred temperature value, an inferred energy load, a predicted weather forecast, identities of individuals granted access to a facility over time, etc. The time series data 408 can further indicate command and/or control data, e.g., the damper position of a VAV over time, the set point of a thermostat over time, etc.

The system 400 includes a schema mapping toolchain 412. The schema mapping toolchain 412 can map the data of the metadata sources 406 into data of the schema 402, e.g., the data in schema 414. The data in schema 414 may be in a schema that can be integrated by an integration toolchain 416 with the building data platform 100 (e.g. ingested into the databases, graphs, and/or knowledge bases of the building data platform 100) and/or provided to the AI services and applications 410 for execution).

The AI services and applications 410 include building control 442, analytics 444, micro-grid management 446, and various other applications 448. The building control 442 can include various control applications that may utilize AI, ML, and/or any other software technique for managing control of a building. The building control 442 can include auto sequence of operation, optimal supervisory controls, etc. The analytics 444 include clean air optimization (CAO) applications, energy prediction model (EPM) applications, and/or any other type of analytics.

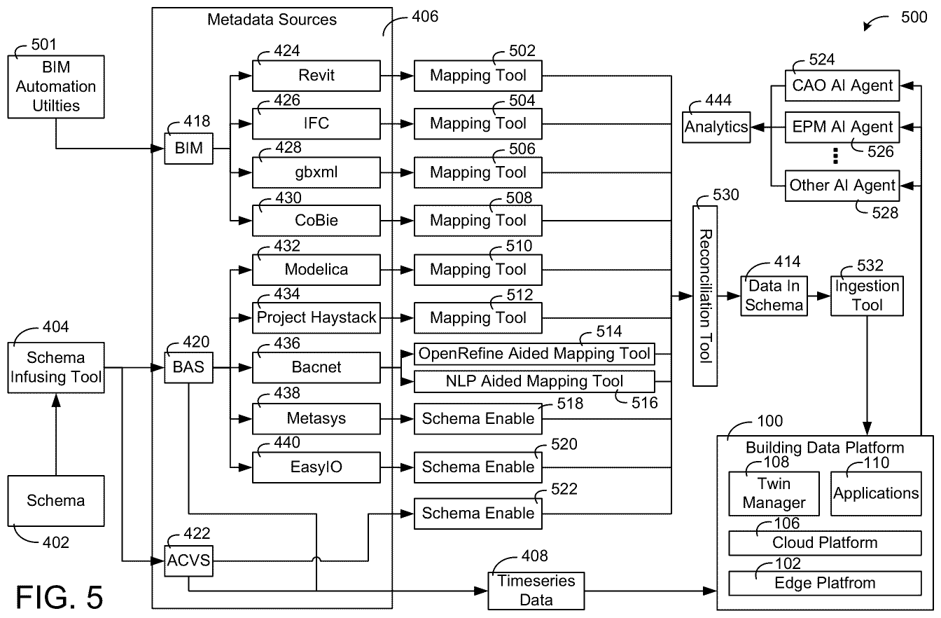

Referring now to FIG. 5, a system 500 including metadata sources 406 being integrated with the building data platform 100 and including AI agents is shown, according to an exemplary embodiment. The system 500 can be implemented on one or more processing circuits, e.g., as instructions stored on one or more memory devices and executed on one or more processors. The memory devices and processors may be the same as or similar to the memory devices and processors described with reference to FIG. 1.

The system 500 includes various tools for converting the metadata sources 406 into the data in schema 414. Various mapping tools 502-512 can map data from an existing schema into the schema 402. For example, the mapping tools 502-512 can utilize a dictionary that provides mapping rules and syntax substitutions. In some embodiments, that data sources can have the schema 402 activated, e.g., schema enable 518-522. If the schema 402 is enabled for a Metasys data source, an easy IO data source, or an ACVS data sources, the output data by said systems can be in the schema 402. Examples of schema mapping techniques can be found in U.S. patent application Ser. No. 16/663,623 filed Oct. 25, 2019, U.S. patent application Ser. No. 16/885,968 filed May 28, 2020, and U.S. patent application Ser. No. 16/885,959 filed May 28, 2020, the entireties of which are incorporated by reference herein.

For the EasyIO data 440, the EasyIO controller objects could be tagged with classes of the schema 402. For the Revit data 424, the metadata of a REVIT model could be converted into the schema 402, e.g., into a resource description format (RDF). For the Metasys data 438, Metasys SCT data could be converted into RDF. An OpenRefine aided mapping tool 514 and/or a natural language aided mapping tool 516 could perform the schema translation for the BACnet data 436.

The schema data output by the tools 502-522 can be provided to a reconciliation tool 530. The reconciliation tool 530 can be configured to merge complementary or duplicate information and/or resolve any conflicts in the data received from the tools 502-522. The result of the reconciliation performed by the reconciliation tool 530 can be the data in schema 414 which can be ingested into the building data platform 100 by the ingestion tool 532. The ingestion tool 532 can generate and/or update one or more graphs managed and/or stored by the twin manager 108. For example, the graph could be any of the graphs described with reference to FIGS. 1-3 or any other graph, as desired for a given application, scenario, or configuration.

The system 500 includes agents that perform operations on behalf of the AI services and applications 410. For example, as shown in the system 500, the analytics 444 are related to various agents, a CAO AI agent 524, an EPM AI agent 526, and various other AI agents 528. The agents 524-528 can receive data from the building data platform 100, e.g., the data that the ingestion tool 532 ingests into the building data platform 100, and generate analytics data for the analytics 444.

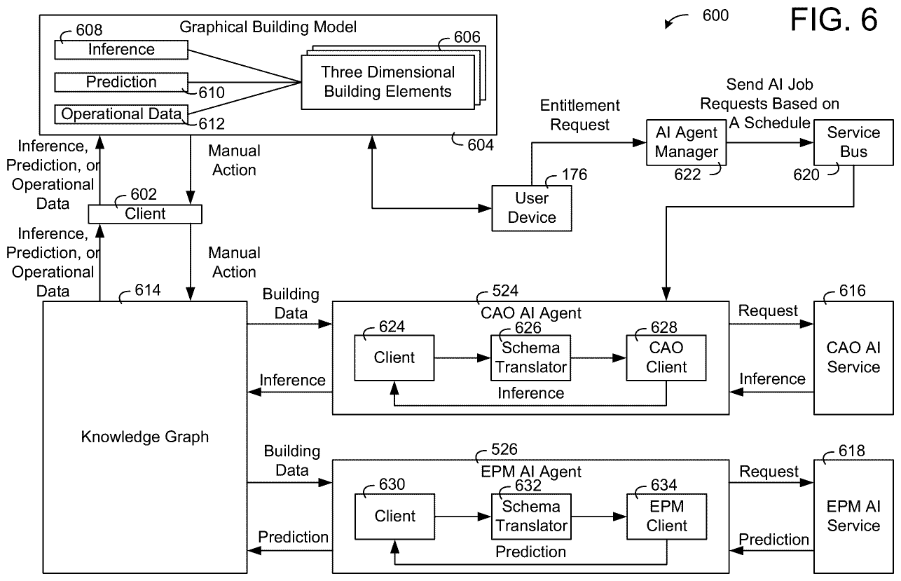

Referring now to FIG. 6, inferences and/or predictions of the CAO AI agent 524 and the EPM AI agent 526 being presented in a three dimensional graphic interface by a system 600 is shown, according to an exemplary embodiment. The system 600 can be implemented on one or more processing circuits, e.g., as instructions stored on one or more memory devices and executed on one or more processors. The memory devices and processors may be the same as or similar to the memory devices and processors described with reference to FIG. 1. It should be appreciated that the inferences and predictions described herein with reference to the CAO AI agent 524 and the EPM AI agent 526 are provided as examples. In some other instances, the system 600 may allow for various other inferences and/or predictions to be presented via various other agents, as desired for a given application, scenario, or configuration.

The system 600 includes a client 602. The client 602 can integrate with the knowledge graph 614 and also with a graphical building model 604 that can be rendered on a screen of the user device 176. For example, the knowledge graph 614 could be any of the graphs described with reference to FIGS. 1-3 or any other graph, as desired for a given application, scenario, or configurations. In some instances, the knowledge graph 614 may be any of the graph projections found in U.S. patent application Ser. No. 17/537,046, referenced above.

The client 602 can retrieve information from the knowledge graph 614, e.g., an inference generated by the CAO AI agent 524, a prediction made by the EPM AI agent 526, operational data stored in the knowledge graph 614, and/or any other relevant information. The client 602 can ingest the values of the retrieved information into the graphical building model 604 which can be displayed on the user device 176. In some embodiments, when a particular visual component is being displayed on the user device 176 for the virtual model 604, e.g., a building, the corresponding information for the building can be displayed in the interface, e.g., inferences, predictions, and/or operational data.

For example, the client 602 could identify a node of the building in the knowledge graph 614, e.g., a building node, such as building node 234. The client 602 could identify information linked to the building node via edges, e.g., an energy prediction node related to the building node via an edge. The client 602 can cause the energy prediction associated with the building node to be displayed in the graphical building model 604.

In some embodiments, a user can provide input through the graphical building model 604. The input may be a manual action that a user provides via the user device 176. The manual action can be ingested into the knowledge graph 614 and stored as a node within the knowledge graph 614. In some embodiments, the manual action can trigger one of the agents 524-526 causing the agent to generate an inference and/or prediction which is ingested into the knowledge graph 614 and presented for user review in the model 604.

In some embodiments, the knowledge graph 614 includes data for the inferences and/or predictions that the agents 524 and 526 generate. For example, the knowledge graph 614 can store information such as the size of a building, the number of floors of the building, the equipment of each floor of the building, the square footage of each floor, square footage of each zone, ceiling heights, etc. The data can be stored as nodes in the knowledge graph 614 representing the physical characteristics of the building. In some embodiments, the CAO AI agent generates inferences and/or the EPM AI agent 526 makes the predictions based on the characteristic data of the building and/or physical areas of the building.

For example, the CAO AI agent 524 can operate on behalf of a CAO AI service 616. Similarly, the EPM AI agent 526 can operate on behalf of an EPM AI service 618. Furthermore a service bus 620 can interface with the agent 524 and/or the agent 526. A user can interface with the agents 524-526 via the user device 176. The user can provide an entitlement request, e.g., a request that the user is entitled to make and can be verified by an AI agent manager 622. The AI agent manager 622 can send an AI job request based on a schedule to the service bus 620 based on the entitlement request. The service bus 620 can communicate the AI job request to the appropriate agent and/or communicate results for the AI job back to the user device 176.

In some embodiments, the CAO AI agent 524 can provide a request for generating an inference to the CAO AI service 616. The request can include data read from the knowledge graph 614, in some embodiments.

The CAO AI agent 524 includes a client 624, a schema translator 626, and a CAO client 628. The client 624 can be configured to interface with the knowledge graph 614, e.g., read data out of the knowledge graph 614. The client 624 can further ingest inferences back into the knowledge graph 614. For example, the client 624 could identify time series nodes related to one or more nodes of the knowledge graph 614, e.g., time series nodes related to an AHU node via one or more edges. The client 624 can then ingest the inference made by the CAO AI agent 524 into the knowledge graph 614, e.g., add a CAO inference or update the CAO inference within the knowledge graph 614.

The client 624 can provide data it reads from the knowledge graph 614 to a schema translator 626 that may translate the data into a specific format in a specific schema that is appropriate for consumption by the CAO client 628 and/or the CAO AI service 616. The CAO client 628 can run one or more algorithms, software components, machine learning models, etc. to generate the inference and provide the inference to the client 624. In some embodiments, the client 624 can interface with the EPM AI service 618 and provide the translated data to the EPM AI service 618 for generating an inference. The inference can be returned by the EPM AI service 618 to the CAO client 628.

The EPM AI agent 526 can operate in a similar manner to the CAO AI agent 524, in some embodiments. The client 630 can retrieve data from the knowledge graph 614 and provide the data to the schema translator 632. The schema translator 632 can translate the data into a readable format by the CAO AI service 616 and can provide the data to the EPM client 634. The EPM client 634 can provide the data along with a prediction request to the CAO AI service 616. The CAO AI service 616 can generate the prediction and provide the prediction to the EPM client 634. The EPM client 634 can provide the prediction to the client 630 and the client 630 can ingest the prediction into the knowledge graph 614.

In some embodiments, the agents 524-526 combined with the knowledge graph 614 can create a digital twin. In some embodiments, the agents 524-526 are implemented for a specific node of the knowledge graph 614, e.g., on behalf of some and/or all of the entities of the knowledge graph 614. In some embodiments, the digital twin includes trigger and/or actions as also described in U.S. patent application Ser. No. 17/537,046, referenced above. In this regard, the agents can trigger based on information of the knowledge graph 614 (e.g., building ingested data and/or manual commands provide via the model 604) and generate inferences and/or predictions with data of the knowledge graph 614 responsive to being triggered. The resulting inferences and/or predictions can be ingested into the knowledge graph 614. The inferences and/or predictions can be displayed within the model 604.

In some embodiments, the animations of the model 604 can be based on the inferences and/or predictions of the agents 524-526. In some embodiments, charts or graphs can be included within the model 604, e.g., charting or graphing time series values of the inferences and/or predictions. For example, if an inference is an inference of a flow rate of a fluid (e.g., water, air, refrigerant, etc.) through a conduit, the speed at which arrows moving through the virtual conduit can be controlled based on the inferred flow rate inferred by an agent. Similarly, if the model 604 provides a heat map indicating occupancy, e.g., red indicating high occupancy, blue indicating medium occupancy, and green indicating low occupancy, an agent could infer an occupancy level for each space of the building and the color coding for the heat map of the model 604 could be based on the inference made by the agent.

In some embodiments, the graphical building model 604 can be a three dimensional or two-dimensional graphical building. The graphical building model 604 can be a building information model (BIM), in some embodiments. The BIM can be generated and viewed based on the knowledge graph 614. An example of rendering graph data and/or BIM data in a user interface is described in greater detail in U.S. patent application Ser. No. 17/136,752 filed Dec. 29, 2020, U.S. patent application Ser. No. 17/136,768 filed Dec. 29, 2020, and U.S. patent application Ser. No. 17/136,785 filed Dec. 29, 2020, the entirety of which is incorporated by reference herein.

In some embodiments, the graphical building model 604 includes one or multiple three-dimensional building elements 606. The three-dimensional building elements 606 can form a building when combined, e.g., can form a building model of a building or a campus model of a campus. The building elements 606 can include floors of a building, spaces of a building, equipment of a building, etc. Furthermore, each three-dimensional building element 606 can be linked to certain data inferences 608, predictions 610, and/or operational data 612. The data 608-612 can be retrieved from the knowledge graph 614 for display in an interface via the user device 176.

Virtual Sensors within the Context of a Digital Twin

Referring now to FIG. 7, a method 700 for generating and utilizing a virtual sensor in the context of a digital twin to detect and/or predict events within a building is shown, according to an exemplary embodiment. It should be noted that the method 700 is provided as an example and is not meant to be limiting. In other implementations, the method 700 may include additional or fewer steps. Additionally, the method 700 may be performed in the same or any other suitable order.

As utilized herein, a “virtual sensor” is an algorithmic abstraction of a physical sensor that is able to perform one or more functions similar to the physical sensor, but using an algorithm that utilizes data from other data sources or devices as a replacement for physical sensing components configured to directly detect the event. In some implementations, virtual sensors may eliminate or substantially eliminate the need for a corresponding physical sensor to be installed or otherwise implemented. As described below, in some embodiments, virtual sensors (e.g., virtual sensor entities and corresponding virtual sensor relationships) can be instantiated in the context of a digital twin of a building and used to detect a variety of events associated with building equipment (e.g., reflected within the digital twin by various entities and corresponding relationships) in the building without requiring installation of additional physical sensors. Thus, users of the system (e.g., the system 300) can quickly and remotely add large numbers of virtual sensors to digital twins of various buildings to detect a number of different events without needing to purchase physical sensors or physically enter the buildings to install physical sensors, in some embodiments.

At step 710, a digital twin is obtained or generated by the system (e.g., system 300). For example, in some instances, the system 300 generates a digital twin that represents a building or other physical space. In some other instances, the system 300 receives or obtains the digital twin from another system. In some instances, the digital twin is represented by and stored as a graph or graph projection (e.g., the graph 329). In some other instances, the digital twin may be represented by and stored in a variety of other forms (e.g., a 2D or 3D representation, another BIM data representation).

At step 720, one or more virtual sensors are generated. The one or more virtual sensors may be generated before, during, or after the digital twin has been generated or obtained, at step 710. In some instances, a plurality of virtual sensors configured to detect a plurality of different events associated with various pieces of building equipment (e.g., an HVAC system, a chiller, a VAV, a furnace, a ventilation system, a manufacturing system, a fire suppression system, a security system) within the building are generated. Each virtual sensor may include or reference a corresponding machine learning model that has been trained to detect a corresponding event associated with the virtual sensor occurring within the building based on one or more data sources. For example, in some instances, the events may include actual refrigerant leaks, predicted refrigerant leaks, a forced door event, system malfunctions, temperature spikes, low air quality events, high pollutant levels, overcrowding events, and/or a variety of other events occurring within a given space.

In some instances, the events detectable by the virtual sensors (e.g., using the machine learning models) may be events that are already occurring. In some instances, the events may be predicted events that are about to occur. For example, in some instances, the virtual sensors (e.g., using the machine learning models) may be configured to identify various parameter trends in corresponding training data that preceded later events and use those trends to predict future events (e.g., if similar parameter trends are identified in received data). In some instances, the virtual sensors (e.g., using the machine learning models) may further indicate where and/or when an event will occur based on trends and/or other patterns identified within corresponding training data used to train the machine learning model. In some instances, the virtual sensors (e.g., using the machine learning models) may further compute a likelihood (e.g., a percentage) that a building event is occurring or is about to occur based on the data received from the various data sources. In some instances, the virtual sensors (e.g., using the machine learning models) may further be configured to detect specific event conditions (e.g., a refrigerant leakage of 5% of the total refrigerant volume in a refrigerant circuit, a refrigerant leakage of 10% of the total refrigerant volume in a refrigerant circuit). In some instances, the virtual sensors (e.g., using the machine learning models) may further be configured to output one or more likely causes of a given event.

In some instances, the machine learning models of the virtual sensors described herein are trained using a variety of historical events (e.g., having differing event conditions) and corresponding contextual training data collected from one or more test data sources (e.g., similar or corresponding to the data sources that will ultimately be utilized to detect the corresponding events within the building) to detect a variety of events occurring within the building. In some instances, the machine learning models are additionally or alternatively trained using simulation data from one or more simulation software programs corresponding to different event conditions associated with the event.

For example, in the context of refrigerant leaks, a machine learning model may be trained using data sets representing, for example, environmental conditions (e.g., temperature, pressure, thermal conductivity, pollutant levels) or other sensed data captured before or during one or more prior refrigerant leaks. The machine learning model may additionally or alternatively be trained using simulated data generated using a simulation model of one or more subsystems (e.g., building subsystems 122) before or during one or more simulated events (e.g., a simulation model of the HVAC system during differing levels of refrigerant leakage).

Examples of training processes that may be utilized to train the machine learning models employed within the virtual sensors described herein may be found in U.S. patent application Ser. No. 18/227,093, filed Jul. 27, 2023, and U.S. patent application Ser. No. 18/240,291, filed Aug. 30, 2023, the entireties of which are incorporated by reference herein. While these applications largely focus on training machine learning models to detect refrigerant leakage conditions, in other contexts, machine learning models can be trained using similar processes and appropriate data sets corresponding to a variety of other events and event conditions to similarly allow for the effective and accurate detection of other events without the need to implement additional physical sensors within the building.

As such, in some instances, the data sources utilized by the virtual sensors (e.g., and ultimately provided as inputs into the corresponding machine learning models) may include data collected by physical sensors (e.g., temperature sensors, pressure sensors, electrical conductivity sensors, thermal conductivity sensors, airflow sensors, air quality sensors, pollutant sensors) associated with system components of various systems within the building. In some instances, the data sources may include Internet of Things (IoT) devices connected to, associated with, or otherwise capturing data relevant to the various systems within the building. As such, the data received by the computer processor may include a variety of differing information. In some instances, the data received may further include occupancy data of a relevant space within the building (e.g., near an area in which an event is to be detected or predicted).

Accordingly, the system (e.g., the system 300) is configured to generate the plurality of virtual sensors and store the virtual sensors within a database (e.g., database 160, 162). For example, in some instances, virtual sensors can be generated to detect a variety of events corresponding to a variety of different components (e.g., various pieces of equipment installed or installable within the building) and stored for later addition into the digital twin (e.g., upon installation of the corresponding pieces of equipment within the building). As such, a user of the system may selectively add the generated virtual sensors to the digital twin by adding a corresponding virtual sensor entity and various virtual sensor relationships into the digital twin.

Accordingly, at step 730, one or more virtual sensors can be added to or otherwise instantiated within the digital twin (e.g., by adding the virtual sensor node 399 to the graph 329, as shown in FIG. 3) and associated with various equipment entities corresponding to pieces of equipment within the building (e.g., by adding the “senses” edge 393 to the graph 329, as shown in FIG. 3) to detect events associated with those pieces of equipment. The one or more added virtual sensors each include or reference a corresponding trained machine learning model configured to detect a corresponding event associated with one or more pieces of equipment within the building.

At step 740, a virtual sensor detects an event. For example, during operation of the system (e.g., the system 300) after the virtual sensors have been added to the digital twin, each of the virtual sensors receives data from various data sources corresponding to the training data or simulation data used to train the corresponding machine learning model of the virtual sensor (e.g., based on the virtual sensor entity and the corresponding virtual sensor relationships added to the digital twin). In some instances, the data is received from the various data sources on a continuous basis. In some other instances, the data is received from the various data sources on a periodic basis (e.g., every 30 seconds, every minute, every 10 minutes, every half hour, every hour).

Each of the virtual sensors is then configured to apply the received data to the corresponding machine learning model to determine whether the received data is indicative of the event configured to be detected by the corresponding virtual sensor. For example, in the context of detecting refrigerant leaks, environmental conditions (e.g., air quality, temperature, thermal conductivity) surrounding a refrigerant circuit (e.g., of an HVAC system or a chiller) may be utilized by the machine learning model of the corresponding virtual sensor to detect an actual or predicted refrigerant leak.

Accordingly, in some instances, the various data sources utilized by the machine learning models of the virtual sensors allow for the detection of one or more events occurring (or about to occur) within an area of the building that does not have physical sensors or that has physical sensors not traditionally utilized for monitoring the detected event. That is, in some instances, the virtual sensors described herein (e.g., utilizing the machine learning models discussed above) may implicitly or inferentially detect various events based on one or more digital twin data sources or other sources that do not directly measure an event-determinative parameter associated with the events.

For example, in the context of a refrigerant leak within an HVAC system, physical refrigerant detections sensors and/or thermal conductivity sensors configured to directly detect the presence of refrigerant outside of an intended refrigerant circuit and/or increased thermal conductivity of an airflow through the HVAC system (e.g., indicative of a refrigerant leakage) could be installed within the HVAC system. However, as described herein, a virtual sensor may instead be employed to implicitly or inferentially detect refrigerant leaks within the HVAC system based on a variety of alternative data sources (e.g., supply and return airflow temperatures, supply and return air pressures, temperatures within spaces near the HVAC system, thermal imaging taken within a given space near the HVAC system) already collected within the HVAC system or within the building generally (i.e., without the need for adding any additional physical sensors). As such, the virtual sensors described herein can be added into digital twins to detect a variety of events within a building, thereby eliminating the need for corresponding physical sensors to be installed and maintained within the building. Further, in some instances, the virtual sensors allow for certain events to be detected in areas of the building where physical sensors are not easy or possible to install.

At step 750, a response to the detected event is initiated. For example, in some instances, upon detecting the event, the virtual sensor entity (e.g., the virtual sensor node 399) is updated to include an indication that the event has occurred. In some instances, in response to the indication that the event has occurred, the system (e.g., the system 300) then generates or initiates one or more response actions. For example, in some instances, the response actions may include the system shutting down one or more subsystems (e.g., building subsystems 122) or other components within the building (e.g., shutting down an HVAC system until the leak subsides). In some instances, the response actions may include the system automatically performing one or more event mitigation actions via one or more subsystems or other components within the building. For example, in the context of a detected refrigerant leak, the system may automatically turn on a fan of an HVAC system to dissipate the air, enable/disable heating within the HVAC system, and/or enable/disable cooling within the HVAC system.

In some instances, the response actions may include the system generating one or more system alerts. The system alerts may include generating and transmitting a warning to a user device (e.g., similar to the user device 176) associated with a manager of the system or generating an audible or visual alert warning occupants in an affected room of the event (e.g., via one or more audio or visual devices within the affected room). For example, in some instances, where a manager of the system is warned, the alert generated and transmitted to the personal device of the manager may include a user interface dashboard associated with the system that includes a location of the event, an estimated time to fix it, and/or one or more mitigation options.

In some embodiments, the response actions may include generating a work order to address the event. For example, if a given event requires a replacement part or one or more repair materials, the system may automatically generate a corresponding work order for the replacement part and/or repair materials. In some instances, a location of the event may be included in the work order, and an automated billing system may be employed to schedule the replacement/repair.

In some instances, the system (e.g., the system 300) may determine a response action for a given event using one or more additional data sources (e.g., other contextual data pulled from the twin manager 108). For example, in some instances, the system may respond differently to a given event within the building depending on an occupancy within a corresponding space within which the event is occurring (e.g., a higher number of occupants within the affected space may lead to a different response action than a lower number of occupants). For example, in the case of a high occupancy room having a refrigerant leak, the system may generate a visual and/or audible alert within the room and also turn on a fan of an HVAC system to dissipate the leaked refrigerant. However, if the affected room is empty, the system may only turn on the fan of the HVAC system.

In some embodiments, the virtual sensors (e.g., using the machine learning models) may determine or identify a need for additional sensors to accurately detect and/or predict events. For example, in some instances, the virtual sensors (e.g., using the machine learning models) may generate confidence scores for each detection and/or prediction. For example, the confidence scores may be a percentage or other metric that is indicative of the corresponding machine learning model's confidence that the corresponding detection or prediction is accurate. In some instances, if the machine learning model generates a confidence score below a confidence score threshold (e.g., 75%), the virtual sensor may output an indication that additional sensors and/or data sources are needed to improve the accuracy of the detection and/or prediction. In some instances, if the virtual sensor determines that additional physical sensors are needed, the system (e.g., the system 300) may prevent users from adding the corresponding virtual sensor entity to the digital twin. For example, if a given virtual sensor is generated to detect a given event using a predetermined set of inputs and a given piece of equipment installed in the building and reflected in the digital twin has fewer than the predetermined set of inputs (e.g., there is a need for additional physical sensors to accurately determine/predict the event), the system (e.g., the system 300) may prevent users from adding that particular virtual sensor to the digital twin.

In some instances, the virtual sensors (e.g., using the machine learning models) may further be configured to determine optimal location(s) to install one or more additional physical devices (e.g., sensors) to collect additional data and increase the accuracy of event detection/prediction within the building. For example, in some instances, the machine learning model may be trained to utilize various data (e.g., airflow measurements taken within a particular air duct) to determine an ideal location to install a new physical sensor (e.g., a leak detection sensor).

As an example, in the context of detecting refrigerant leaks, the machine learning model may identify a suggested installation location for one or more additional physical sensors based on an airflow rate within a given area. For example, the machine learning model may suggest installing one or more additional physical sensors (e.g., refrigerant detection sensors) within an area of the building that has a high airflow rate. If, for example, there is an actual refrigerant leak, additional sensors placed in an area with a high airflow rate may be able to detect the refrigerant leak more quickly and/or reliably than sensors placed in an area with a low airflow rate. In some instances, the machine learning model may additionally be trained to indicate how many additional sensors or devices are necessary to improve the system.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed:

1. A method comprising:
generating or obtaining, by one or more processors, a digital twin of a building, the digital twin comprising a plurality of entities and a plurality of relationships between the plurality of entities, the plurality of entities comprising digital representations of one or more pieces of building equipment of the building;
generating, by the one or more processors, a virtual sensor configured to detect an event associated with the one or more pieces of building equipment, the virtual sensor comprising a machine learning model configured to detect the event using data obtained from and/or relating to the one or more pieces of building equipment;
adding, by the one or more processors, a virtual sensor entity and one or more virtual sensor relationships to the digital twin, the virtual sensor entity corresponding to the virtual sensor, the one or more virtual sensor relationships connecting the virtual sensor entity to one or more of the plurality of entities representing the one or more pieces of building equipment;
detecting, by the one or more processors using the virtual sensor, that the event has occurred; and
in response to detecting the event has occurred, updating the virtual sensor entity to include an indication that the event has occurred.

2. The method of claim 1, wherein generating the virtual sensor comprises:
collecting one of test data from one or more test data sources associated with the one or more pieces of building equipment or simulation data from one or more simulation software programs, the one of the test data or the simulation data corresponding to an event condition associated with the event;
training the machine learning model to detect the event using the one of the test data or the simulation data; and
generating the virtual sensor including the trained machine learning model.

3. The method of claim 2, wherein the virtual sensor is configured to:
receive the data obtained from and/or relating to the one or more pieces of building equipment, the data corresponding to the one of the test data or the simulation data;
apply the data to the trained machine learning model; and
generate the indication that the event has occurred based on an output of the trained machine learning model.

4. The method of claim 1, wherein the data obtained from and/or relating to the one or more pieces of building equipment is received by the virtual sensor based on the one or more virtual sensor relationships connecting the virtual sensor entity to the one or more of the plurality of entities representing the one or more pieces of building equipment.

5. The method of claim 1, further comprising, in response to the virtual sensor entity being updated to include the indication that the event has occurred, initiating, by the one or more processors, a response action based on at least one of the one or more virtual sensor relationships or additional context from the digital twin.

6. The method of claim 5, wherein the response action includes one or more of generating a system alert, generating a work order to address the event, shutting off one or more components associated with the one or more pieces of building equipment, powering on the one or more components, or modifying operation of the one or more components.

7. The method of claim 1, wherein the event comprises one or more of an actual refrigerant leak, a predicted refrigerant leak, a forced door event, or a system malfunction.

8. The method of claim 1, wherein adding the virtual sensor entity and the one or more virtual sensor relationships to the digital twin comprises adding the virtual sensor entity and the one or more virtual sensor relationships to a graph projection of the digital twin.

9. The method of claim 1, wherein generating the virtual sensor configured to detect the event associated with the one or more pieces of building equipment comprises generating a plurality of virtual sensors configured to detect a plurality of events associated with a plurality of pieces of building equipment, each virtual sensor of the plurality of virtual sensors configured to detect a different event associated with a different piece of building equipment.

10. A building system of a building, the building system comprising:
one or more memory devices having instructions thereon, that, when executed by one or more processors, cause the one or more processors to:
generate or obtain a digital twin of the building, the digital twin comprising a plurality of entities and a plurality of relationships between the plurality of entities, the plurality of entities comprising digital representations of one or more pieces of building equipment of the building;
generate a virtual sensor configured to detect an event associated with the one or more pieces of building equipment, the virtual sensor comprising a machine learning model configured to detect the event using data obtained from and/or relating to the one or more pieces of building equipment;
add a virtual sensor entity and one or more virtual sensor relationships to the digital twin, the virtual sensor entity corresponding to the virtual sensor, the one or more virtual sensor relationships connecting the virtual sensor entity to one or more of the plurality of entities representing the one or more pieces of building equipment;
detect, using the virtual sensor, that the event has occurred; and
in response to detecting the event has occurred, updating the virtual sensor entity to include an indication that the event has occurred.

11. The building system of claim 10, wherein generating the virtual sensor comprises:
collecting one of test data from one or more test data sources associated with the one or more pieces of building equipment or simulation data from one or more simulation software programs, the one of the test data or the simulation data corresponding to an event condition associated with the event;
training the machine learning model to detect the event using the one of the test data or the simulation data; and
generating the virtual sensor including the trained machine learning model.

12. The building system of claim 11, wherein the virtual sensor is configured to:
receive the data obtained from and/or relating to the one or more pieces of building equipment, the data corresponding to the one of the test data or the simulation data;
apply the data to the trained machine learning model; and
generate the indication that the event has occurred based on an output of the trained machine learning model.

13. The building system of claim 10, wherein the data obtained from and/or relating to the one or more pieces of building equipment is received by the virtual sensor based on the one or more virtual sensor relationships connecting the virtual sensor entity to the one or more of the plurality of entities representing the one or more pieces of building equipment.

14. The building system of claim 10, wherein the instructions further cause the one or more processors to, in response to the virtual sensor entity being updated to include the indication that the event has occurred, initiate a response action based on at least one of the one or more virtual sensor relationships or additional context from the digital twin.

15. The building system of claim 14, wherein the response action includes one or more of generating a system alert, generating a work order to address the event, shutting off one or more components associated with the one or more pieces of building equipment, powering on the one or more components, or modifying operation of the one or more components.

16. The building system of claim 10, wherein the event comprises one or more of an actual refrigerant leak, a predicted refrigerant leak, a forced door event, or a system malfunction.

17. The building system of claim 10, wherein adding the virtual sensor entity and the one or more virtual sensor relationships to the digital twin comprises adding the virtual sensor entity and the one or more virtual sensor relationships to a graph projection of the digital twin.

18. The building system of claim 10, wherein generating the virtual sensor configured to detect the event associated with the one or more pieces of building equipment comprises generating a plurality of virtual sensors configured to detect a plurality of events associated with a plurality of pieces of building equipment, each virtual sensor of the plurality of virtual sensors configured to detect a different event associated with a different piece of building equipment.

19. One or more memory devices having instructions thereon that, when executed by one or more processors, cause the one or more processors to:
generate a virtual sensor configured to detect an event associated with one or more pieces of building equipment of a building, the virtual sensor comprising a machine learning model configured to detect the event using data obtained from and/or relating to the one or more pieces of building equipment;
add a virtual sensor entity and one or more virtual sensor relationships to a digital twin, the digital twin comprising a plurality of entities and a plurality of relationships between the plurality of entities, the plurality of entities comprising digital representations of the one or more pieces of building equipment, the virtual sensor entity corresponding to the virtual sensor, the one or more virtual sensor relationships connecting the virtual sensor entity to one or more of the plurality of entities representing the one or more pieces of building equipment;
detect, using the virtual sensor, that the event has occurred; and
in response to detecting the event has occurred, updating the virtual sensor entity to include an indication that the event has occurred.

20. The one or more memory devices of claim 19, wherein the instructions further cause the one or more processors to:
in response to the virtual sensor entity being updated to include the indication that the event has occurred, initiate a response action based on at least one of the one or more virtual sensor relationships or additional context from the digital twin.
